(19) United States
(12) Patent Application Publication
(10) Pub. No.: US 2006/0124843 A1
(43) Pub. Date: Jun. 15, 2006

(54) Optical detection device for a counter

(76) Inventors: Laurent Demja, Montluel (FR); Serge Bulteau, Julienas (FR); Alain Cros, Creches Sur Saone (FR)

Correspondence Address: SOFER & HAROUN LLP., 317 MADISON AVENUE, SUITE 910, NEW YORK, NY, 10017, US

(21) Appl. No.: 10/533,156

(22) PCT Filed: Jan. 30, 2004
(86) PCT No.: PCT/FR04/00230

§ 371 Date: Dec. 15, 2005

(30) Foreign Application Priority Data
Feb. 5, 2003 (FR) 0301319

(51) Int. Cl. G01D 5/34

(52) U.S. Cl. 250/231.13

(57) ABSTRACT

An optical detection device for a counter, comprising a consumption indicator, formed from a rotating disc (4), provided with at least one section called active and optical elements of the emitter type and receiver type, opposite the disc, the received optical signal from which is used to infer the number of rotations of the disc. According to the invention, the disc (4) comprises at least three sectors (4A, 4B, 4C) with a central angle of 120°, each sector being covered on the face thereof facing the outside of the counter (1) with a different color. Said optical elements comprise at least one emitter element (6), emitting a beam of light with at least two different colors ands a receiver element (7) for a reflected light beam.

The present invention pertains to an optical detector device for a meter, a fluid meter in particular e.g. water, to enable remote readout of the consumption of this water meter, or equivalent operations of logging or alert type.

More precisely it concerns an optical detector device for a meter, comprising a consumption indicator formed of a rotating disc provided with at least one so-called active sector and optical elements of emitting and receiving type opposite said disc, whose received optical signal is processed to infer at least the number of rotations of said disc. Said device is known from patent EP 0 380 794.

According to this document, the device comprises an optical detector which is arranged outside the meter and which is adapted to produce an effective signal whenever an index or active sector arranged on a disc passes in front of the detector. This signal is amplified and converted into a square wave so that it can be sent onto a data transmission network. With said detection device, it is possible to determine the number of disc rotations but it is not possible to determine the direction of rotation of this disc.

Yet a fluid meter, in particular a water meter, can operate both on fluid input and on fluid output. This is the case for example when water mains are emptied during construction works, or on flow surges causing water return movement.

The consumption display device, for example an arrangement of dials with digits, takes this into consideration.

The purpose of the invention is to provide an optical detector device able to determine the direction of flow of the water and hence the direction of rotation of the indicator disc so as to take into account consumption which can be termed negative and to provide identical consumption data to the data provided by the conventional display device of the meter.

For this purpose, the invention proposes an optical detector device for a meter comprising a consumption indicator formed of a rotating disc, provided with at least one so-called active sector and optical elements of emitting type and receiving type opposite said disc, whose received optical signal is processed to infer at least the number of rotations of the disc, characterized in that said disc comprises at least three sectors having a centre angle of 120°, each of the sectors being coated with a different color on its surface facing outwardly from the meter, and said optical elements comprise at least one emitting element to emit a light beam of at least two different colors and a receiving element of a reflected light beam.

The choice of three sectors with a centre angle of 120° ensures optimisation of the frequency of emission of the emitter(s) in relation to electric power consumption. Said meters or said modules are battery powered and it is highly advantageous that they should have low power consumption. By choosing a single sequence irrespective of state, the states are in equilibrium in terms of angle and duration at constant speed.

These optical elements may be integrated in one same component and an adequate cover on the meter and module can limit stray light beams.

Advantageously, the optical element operates sequentially.

The positioning of the elements may be such that the angle of incidence of the optical beam emitted and received by the optical elements is less than 60°.

The device may comprise an optical beam collimation device and this collimator device may comprise slits to limit stray interference between light beams.

With this arrangement it is possible to obtain sharper state transitions and improved coupling between optical emitters and receivers.

The invention also concerns a fluid meter comprising a rotating disc that is part of an optical detector device such as described above.

Finally, the invention concerns a detection module intended to cooperate with a fluid meter and comprising said optical elements that are part of a device such as described above.

Advantageously, this module also comprises an optical beam collimator device.

The invention is described below in more detail with the aid of figures which only show one preferred embodiment of the invention.

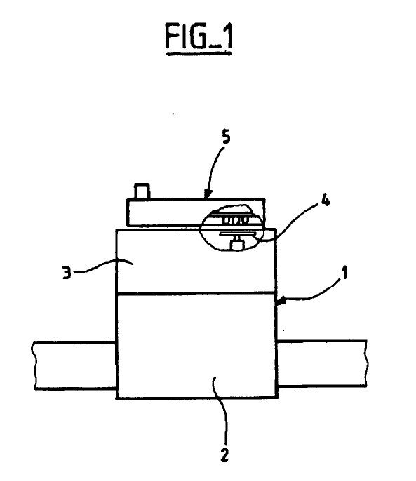

FIG. 1 is a view of the meter and of a module according to the invention.

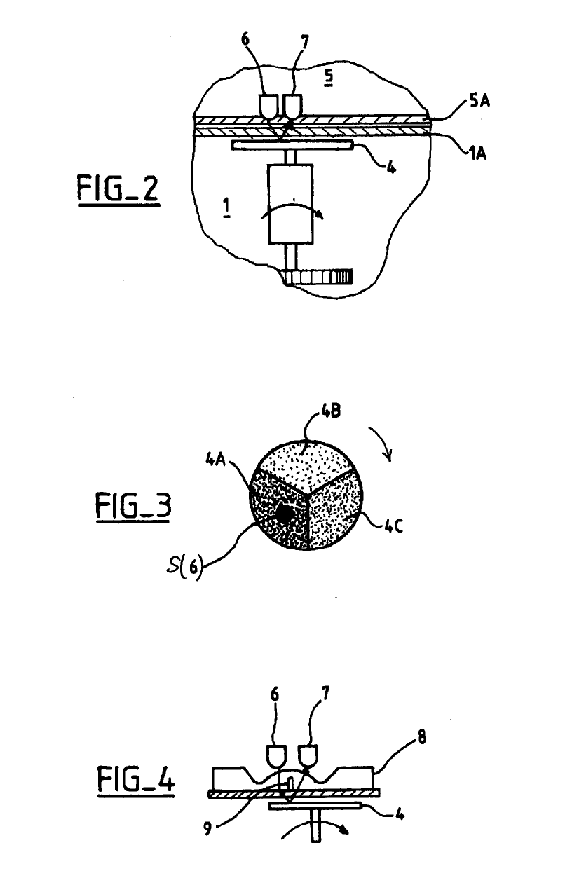

FIG. 2 is a cross-section view of a detection device of the invention according to a first embodiment.

FIG. 3 is an overhead view of a rotating disc that is part of a detection device of the invention.

FIG. 4 is a cross-section view of a detection device of the invention, according to a second embodiment.

FIG. 5 is a partial cross-section view of a variant of embodiment of a detection device of the invention.

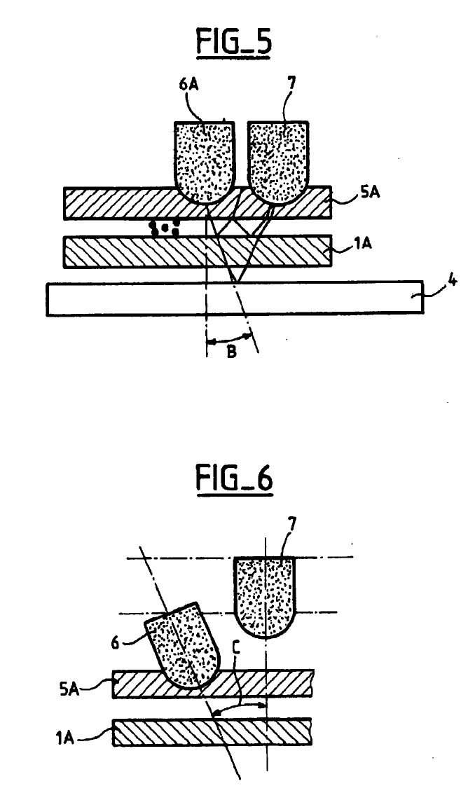

FIG. 6 is partial cross-section view of another variant of embodiment of a detection device of the invention.

FIG. 1 is a front view of a fluid meter 1, more precisely a water meter, comprising a casing 2 provided with a water inlet pipe and outlet pipe surmounted by a totallizer 3 containing a transmission and shaft rotation gear mechanism for a measuring element such as a turbine or volumetric chamber contained in casing 2 which transmits to a consumption display device not shown, and a rotating indicator disc 4 parallel to an upper transparent wall of the totallizer.

An optical detection module 5 whose lower wall is at least partly transparent, is positioned on the upper wall of meter 1 in order to detect water consumption and its direction of flow.

FIG. 2 illustrates the optical detection device of the invention in more detail.

Meter 1 therefore comprises a transparent wall 1A and parallel to this wall is an indicator disc 4 driven by a transmission mechanism. This disc comprises three sectors 4A, 4B, 4C with a centre angle of 120°, each of the sectors being coated in a different color on its surface facing outwardly from the meter.

Arranged so that they arrive opposite the disc 4 when the module is positioned on the meter 1, module 5 comprises two optical elements, more precisely one optical emitter 6, and one optical receiver 7. When considering axis A of disc 4, the optical receiver 7 is offset from this axis A and the two optical elements 6 and 7 are aligned parallel to a diameter of disc 4.

Preferably, the optical emitter is a LED diode emitting a beam of two different wavelengths, and here of two different colors, which passes through the two transparent walls 5A, 1A, is reflected on disc 4 and is received by optical receiver 7, preferably consisting of a photodiode or a phototransistor. The optical emitter 6 operates sequentially in one color and in the other which makes it possible to determine the signals and corresponding states and has the advantage of requiring low overall power consumption. The light beam is emitted in frequency pulse form related to the maximum rotation speed of the target.

FIG. 3 shows A relative position of disc 4 and traces on this disc of the beam S(6A) emitted by the emitter, as seen along a plane perpendicular to axis A of the disc.

The direction of rotation of the disc is shown by an arrow, this direction corresponding to normal positive fluid consumption.

According to one particular embodiment, the first sector 4A is coated a red color, the second sector 4B a green color, and the third sector 4C a yellow color which is the color obtained by subtractive synthesis of red and green. The optical emitting element 6 sequentially emits a red light pulse and a green light pulse and the signal received is analysed each time.

The table below summarizes the received signals according to the different states of the target and optical emitter.

| | | Signal | |
|---|---|---|---|
| Color emitted | Color of disc | received | Comment |
| Red | Red | 0 | Red is |
| | | | absorbed by |
| | | | the target |
| | Green | 1 | Red is |
| | | | reflected by |
| | | | the target |
| | Yellow | Intermediate | Only one part |
| | | | is reflected |
| Green | Red | 1 | Green is |
| | | | reflected by |
| | | | the target |
| | Green | 0 | Green is |
| | | | absorbed by |
| | | | the target |
| | Yellow | Intermediate | Only one part |
| | | | is reflected |
| Red | No target | 0 | No meter |
| Green | No target | 0 | |

In positive consumption, the series of signals received is therefore (0,1) . . . , (1,0) . . . , (intermediate, intermediate) . . . and the frequency of their state changes is used to determine the rotation speed of the indicator disc 4 and hence of consumption. A series comprising one of the preceding pairs in another order enables detection of a change in the direction of rotation of indicator disc 4 and hence a negative consumption.

The signals received are therefore pairs of values and under no circumstances is a received signal equal to (0,0) at the time of detection, when the module is in position on the meter. With this arrangement, it is possible to detect the presence of the module on the meter: the signal being (0,0) if the module is absent. In this manner it is possible to detect any fraudulent or improper positioning.

Within the scope of the invention it is possible to have more than three colored sectors on the disc and to emit more than two colors.

In the above, optical elements 6,7 are advantageously SMD optical components (Surface Mounted Devices) and are simple i.e. the components have no integrated collimation.

According to this other embodiment illustrated FIG. 4, an optical beam collimation device 8, of lens type, is either inserted between the transparent wall 5A of module 5 and the optical elements 6, 7, or it directly forms the transparent wall 5A of module 5 configured as a collimation device.

A slit 9 is made in this collimation device 8 to limit stray interference between the light pulses emitted and received by the different optical elements 6, 7.

In lieu and stead of these slits, a separator wall may be used between the optical emitter and receiver.

Optical elements 6,7 here may also be SMD components (Surface Mounted Devices).

FIG. 5 illustrates a variant of embodiment of the invention.

Although a sealing device may be provided between the reading module and the totallizer, of gasket or press fit type for example, solid or liquid dirt or particles may deposit on the transparent wall 1A of meter 1, interfering with transmission of the light beam through the transparent walls 1A, 5A of meter 1 and of detection module 5.

To minimize this interference, optical elements 6, 7 are arranged very close to each other so that the angle of incidence B of this beam is very small and preferably less than 60°. Therefore any power losses of the beam due to particles or dirt are minimum and the beam transmitted through the transparent walls remains of high power. Preferably, the distance between optical elements 6, 7 is less than 2 mm.

Another solution for minimising this angle of incidence B is to choose an adequate distance between the optical elements and the disc, angle B being smaller the greater this distance.

FIG. 6 illustrates another variant of the invention.

Here the optical receiver 7 is arranged with its axis of symmetry oriented in the direction of the light beam perpendicular to the transparent wall 1A of the module, and the optical emitter 6 has its own equivalent axis of symmetry in a plane perpendicular to this wall 1A but at an angle C with respect to this axis of symmetry of the central optical receiver 7. Preferably, this angle C is less than 60°. Also the receiver 7 is positioned above the emitting diode 6 to avoid any direct coupling between emitter and receiver without passing through the rotating target.

1. Optical detector device for a meter, comprising:
a consumption indicator formed of a rotating disc provided with at least one so-called active sector and optical elements of emitting type and receiving type opposite said disc, whose received optical signal is processed to infer at least the number of rotations of said disc, wherein said disc includes at least three sectors with a centre angle of 120°, each of the sectors being coated in a different color on its surface facing outwardly from the meter, and said optical elements include at least one emitting element emitting a light beam of at least two different colors, and a receiving element receiving a reflected light beam.

2. Device as in claim 1, wherein said optical emitter operates sequentially.

3. Device as in claim 1, wherein the positioning of said optical elements is such that the angle of incidence (B) of the optical beam emitted and received by the optical elements is less than 60°.

4. Device as in claim 1 further comprising a collimator device for the optical beam.

5. Device as in claim 4, wherein said collimator device comprises slits limiting stray interference between light beams.

6. Fluid meter comprising a rotating disc that is part of an optical detector device as in claim 1.

7. Detection module intended to cooperate with a fluid meter having said optical elements that are part of a device as in claim 1.

8. Module as in claim 7, further comprising an optical beam collimation device.
